(19) United States
(12) Patent Application Publication
(10) Pub. No.: US 2011/0293201 A1
(43) Pub. Date: Dec. 1, 2011

(54) IMAGE RECORDING DEVICE AND COMPUTER PROGRAM PRODUCT OF IMAGE RECORDING

(75) Inventors: Hiroki UWAI, Yokohama-shi (JP); Naoki YAMAGATA, Shiki-shi (JP); Toshihisa KUROIWA, Miura-shi (JP); Masaharu ARAKAGE, Yokosuka-shi (JP)

(73) Assignee: NIKON CORPORATION, Tokyo (JP)

(21) Appl. No.: 13/027,665

(22) Filed: Feb. 15, 2011

(30) Foreign Application Priority Data
Mar. 12, 2010 (JP) 2010-055984

(51) Int. Cl. G06K 9/54

(52) U.S. Cl. 382/305

(57) ABSTRACT

An image recording device includes: a recording unit that records into a first image file that contains a plurality of sets of image data, common information that can be set by a user as information commonly applicable to all sets of image data in the first image file and individual information that can be individually set by the user for each set of image data in the first image file; and an information modifying unit that modifies the common information based upon information set for the first image file and modifies the individual information corresponding to image data in the first image file based upon information set for the image data.

### INCORPORATION BY REFERENCE

The disclosure of the following priority application is herein incorporated by reference: Japanese Patent Publication No. 2010-055984 filed Mar. 12, 2010

### BACKGROUND OF THE INVENTION

1. Field of the Invention

The present invention relates to an image recording device and an image recording program product.

2. Description of Related Art

There are image-capturing devices known in the related art that record a plurality of sets of image data obtained through a continuous shooting operation, into a single image file (see, for instance, Japanese Laid Open Patent Publication No. 2009-213150).

### SUMMARY OF THE INVENTION

However, the image-capturing devices in the related art are not equipped with a means for managing metadata set as common data for all the image data within the image file and metadata individually set for each image by distinguishing one type of metadata from the other type of metadata.

According to the 1st aspect of the present invention, an image recording device, comprises: a recording unit that records into a first image file that contains a plurality of sets of image data, common information that can be set by a user as information commonly applicable to all sets of image data in the first image file and individual information that can be individually set by the user for each set of image data in the first image file; and an information modifying unit that modifies the common information based upon information set for the first image file and modifies the individual information corresponding to image data in the first image file based upon information set for the image data.

According to the 2nd aspect of the present invention, in the image recording device according to the 1st aspect, it is preferred that: the image recording device further comprises an image file creation unit that creates a second image file based upon at least one set of image data in the first image file; and the recording unit carries over at least either the common information or the individual information having been recorded in the first image file used as a source for creating the second image file and records carried over information into the second image file created by the image file creation unit.

According to the 3rd aspect of the present invention, in the image recording device according to the 2nd aspect, it is preferred that if the first image file has been created as a result of a continuous shooting operation, the recording unit carries over the individual information in the first image file and records the carried over individual information into the second image file, and if the first image file has been created as a result of a multiple viewpoint shooting operation, the recording unit carries over the common information from the first image file and records the carried over common information into the second image file.

According to the 4th aspect of the present invention, in the image recording device according to the 1st aspect, it is preferred that: the image recording device further comprises an image data adding unit that additionally records image data originating from a third image file into the first image file; and when image data are added into the first image file by the image data adding unit, the recording unit records the individual information recorded in the third image file, which pertains to the image data having been added, as the individual information for the image data having been added into the first image file.

According to the 5th aspect of the present invention, in the image recording device according to the 4th aspect, it is preferred that if no individual information is recorded in the third image file in correspondence to image data in the third image file, the recording unit records the common information recorded in the third image file as the individual information pertaining to the image data having been added into the first image file.

According to the 6th aspect of the present invention, in the image recording device according to the 1st aspect, it is preferred that the information modifying unit determines whether the common information or the individual information is to be modified, in correspondence to a specific photographing method through which the plurality of sets of image data in the first image file have been obtained.

According to the 7th aspect of the present invention, in the image recording device according to the 6th aspect, it is preferred that if the photographing method is a continuous shooting method, the information modifying unit modifies the individual information based upon the information set for the image data in the first image file, and if the photographing method is a multiple viewpoint shooting method, the information modifying unit modifies the common information based upon the information set for the image data in the first image file.

According to the 8th aspect of the present invention, a computer program product includes an image recording program enabling a computer to execute: a recording step of recording into a first image file containing a plurality of sets of image data, common information that can be set by a user as information applicable to all sets of image data in the first image file, and individual information that can be set by the user individually for each set of image data in the first image file; and an information modifying step of modifying the common information based upon information set for the first image file, and the individual information corresponding to image data in the first image file based upon information set for the image data.

### BRIEF DESCRIPTION OF THE DRAWINGS

FIG. 1 is a block diagram showing a structure that may be adopted in a personal computer in an embodiment.

FIGS. 2A to 2C schematically illustrate data structures that may be adopted for an MPF file.

FIG. 3 presents a flowchart of the image display processing.

FIG. 4 is a first diagram presenting image display examples.

FIG. 5 is a second diagram presenting image display examples.

FIG. 6 presents a flowchart of the rating processing.

FIG. 7 schematically illustrates how a new image file may be created in a specific example.

FIG. 8 schematically illustrates how main image data may be added to an MPF file in a specific example.

FIG. 9 shows how the programs may be provided.

### DESCRIPTION OF PREFERRED EMBODIMENTS

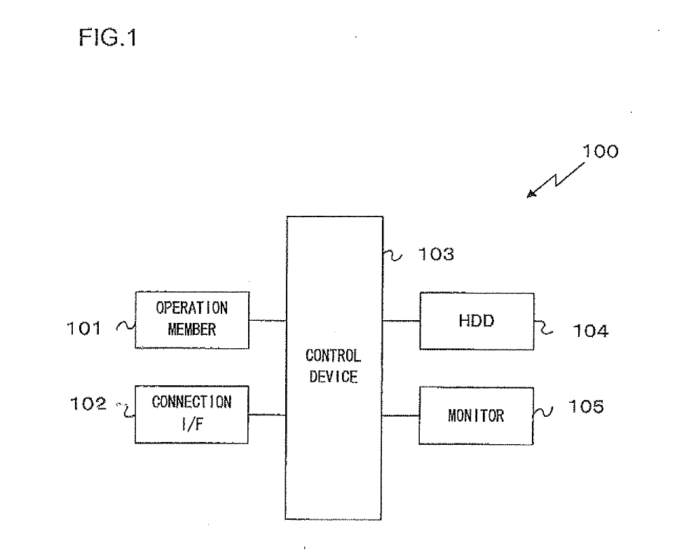

FIG. 1 is a block diagram showing a structure that may be adopted in a personal computer in an embodiment of the present invention. A personal computer 100 comprises an operation member 101, a connection I/F (interface) 102, a control device 103, an HDD (hard disk drive) 104 and a monitor 105.

The operation member 101 includes various devices operated by the user, such as a keyboard and a mouse. The connection I/F 102, via which an external device such as a digital camera is connected, may be a USB interface through which the computer can be connected with a digital camera or a video camera through a wired connection or a wireless LAN module through which the computer can be wirelessly connected with the external device. In the embodiment, image file data in, for instance, a digital camera, are taken into the computer via the connection I/F 102.

An image file taken into the computer via the connection I/F 102 in the embodiment contains main image data in a predetermined image format, e.g., the JPEG format, display image data such as thumbnail data generated based upon the main image data and header information (additional information) that includes various types of image-related information. The image file source digital camera from which the image file is obtained in the embodiment is capable of creating an image file containing a single set of main image data and an image file containing a plurality of sets of main image data.

Namely, the digital camera is capable of creating an image file containing a plurality of sets of image data expressing a batch of images photographed through a single operation such as a batch of images photographed through a continuous shooting operation or a batch of images photographed through a multiple viewpoint shooting session (operation), e.g., panorama shooting, multi-angle shooting or multi-view shooting. In addition, in response to an instruction issued by the user wishing to incorporate image data in a plurality of image files into a single image file, the digital camera creates an image file containing a plurality of sets of specified image data. It is to be noted that the following description of the embodiment is provided by assuming that the multiple viewpoint shooting session (operation) is specifically a panorama shooting operation.

An image file containing a single set of main image data and an image file containing a plurality of sets of main image data can be distinguished from each other based upon their file name extensions, since “.JPG” is appended as the file name extension for an image file containing a single set of main image data and “.MPO” is appended as the file name extension for an image file containing a plurality of sets of main image data. In the description of the embodiment, an image file containing a single set of main image data will be referred to as a JPEG file and an image file containing a plurality of sets of main image data will be referred to as an MPF file.

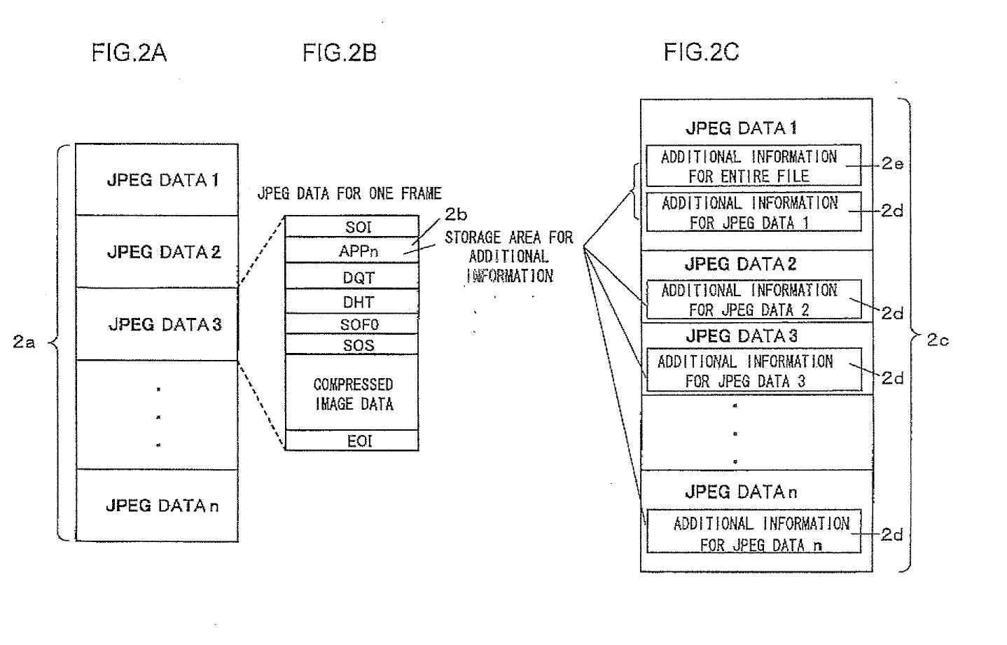

It is to be noted that the JPEG file format conforming to the Exif standard (exchangeable image file format for digital still cameras) of the known art will not be explained in detail here and that the following description, given in reference to FIGS. 2A through 2C will focus on the MPF file format. FIGS. 2A through 2C schematically illustrate data structures that may be adopted for an MPF file.

An MPF file may adopt a data structure such as that shown in FIG. 2A with a plurality of sets of PEG data 1 through n recorded within a single image file 2a. Each set of JPEG data assumes a standard data structure, such as that shown in FIG. 2B, with additional information pertaining to each set of JPEG data, e.g., an image ID to be used to identify the particular image and rating information indicating the rating awarded to the image, recorded in an APPn2b area. As an alternative, an MPF file may adopt the data structure shown in FIG. 2C. In the example presented in FIG. 2C, a single image file 2c includes a plurality of sets of JPEG data 1 through n recorded therein. In addition, each set of JPEG data contains additional information (individual additional information) 2d pertaining to the particular set of PEG data, and additional information (common additional information) 2e pertaining to the entire image file 2c is recorded as part of the JPEG data 1 recorded first in the image file 2c. The embodiment is described by assuming that the MPF file adopts the data structure shown in FIG. 2C.

It is to be noted that while various types of information such as image file label information, rating information or IPTG information, may be recorded as the additional information, the embodiment is described in reference to the rating information as a specific example. The rating information recorded as the individual additional information 2d indicates the rating set for the corresponding main image data, whereas the rating information recorded as the common additional information 2e indicates the common rating set for all the sets of main image data, i.e., the common rating set for the entire MPF file. It is to be noted that in a JPEG file containing a single set of main image data, rating information indicating the rating for the single set of main image data alone can be set.

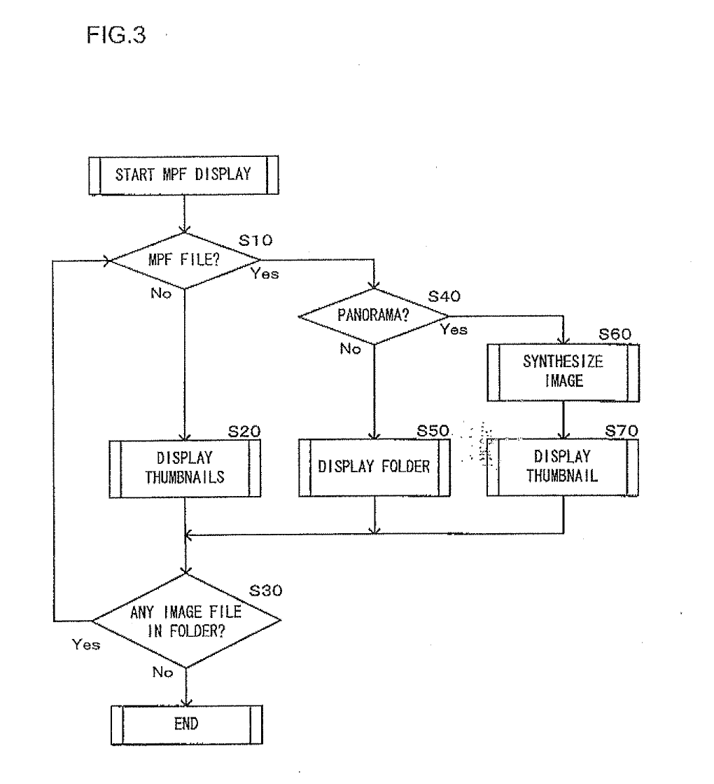

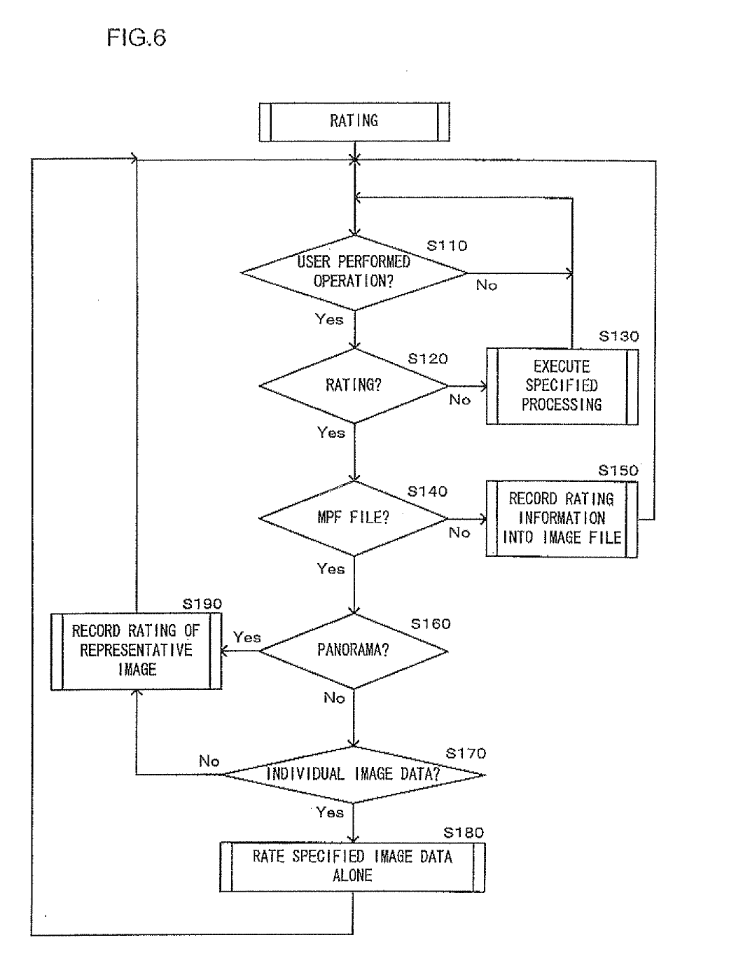

The HDD 104 is a recording device in which an image file taken in via the connection I/F 102, various programs executed by the control device 103 and the like are recorded. For instance, program data enabling execution of the processing to be described in reference to FIG. 3 and FIG. 6 are recorded in the HDD 104. The programs may be provided via a storage medium, such as a CD-ROM or a DVD-ROM, in which they are recorded. Once the user installs the program data, provided via the storage medium, into the HDD 104, the control device 103 in the personal computer 100 is able to execute the programs. At the monitor 105, which may be a liquid crystal monitor, an image expressed with display data output from the control device 103 is brought up on display.

The control device 103, constituted with a CPU, a memory and other peripheral circuits, executes overall control for the image processing device 100. It is to be noted that the memory constituting the control device 103 may be, for instance, a volatile memory such as an SDRAM. This memory may be used as a work memory where a program is opened when the CPU executes the program or as a buffer memory where data are temporarily recorded.

The control device 103 in the embodiment is able to set or change rating information, which is recorded as the additional information, in a JPEG file or an MPF file recorded in the HDD 104, in response to a user instruction. In addition, the control device 103 is also able to display the rating information recorded in the image file together with the corresponding image at the monitor 105.

FIG. 3 presents a flowchart of the image display processing executed in the embodiment. The processing shown in FIG. 3 is executed by the control device 103 with a program that is started up in response to an image display instruction issued by the user by operating the operation member 101. The following description of the embodiment is given by assuming that the user issues an image display instruction by selecting a folder within the HDD 104 in an application screen and then specifying an image file recorded in the selected folder as a display target.

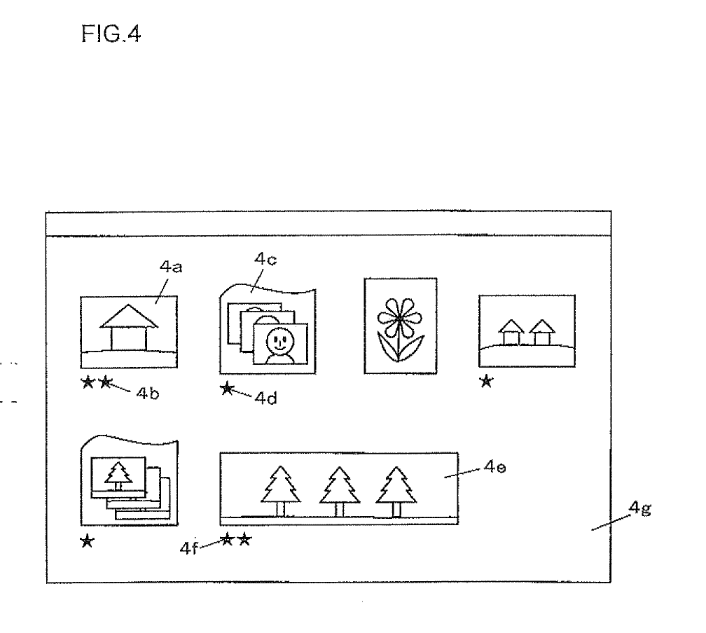

In step S10, the control device 103 selects a specific image file within the folder as a display target and makes a decision as to whether or not the display target image file is an MPF file. If a negative decision is made in step S10, i.e., if the display target image file is judged to be a JPEG file, the operation proceeds to step S20, in which the control device 103 reads out a thumbnail image from the JPEG file and brings up the thumbnail image 4a on display at the monitor 105, as shown in FIG. 4. In addition, the control device 103 reads out the rating information included in the additional information within the JPEG file and displays a star mark 4b, indicating the rating having been read out in relation to the thumbnail image 4a. The user is thus able to view the rating information set for the image corresponding to the thumbnail image 4a on display. Subsequently, the operation proceeds to step S30 to be described later.

If on the other hand, an affirmative decision is made in step S10, the operation proceeds to step S40. In step S40, the control device 103 makes a decision as to whether or not the display target image file is an MPF file containing a plurality of sets of image data expressing a batch of images photographed through multi-viewpoint shooting such as a panorama shooting session. It is to be noted that information indicating whether or not the display target image file contains images having been obtained through panorama shooting is recorded as part of the common additional information 2e in the image file. If a negative decision is made in step S40, i.e., if it is decided that the display target image file does not contain images having been obtained through panorama shooting, the operation proceeds to step S50.

In step S50, the control device 103 brings up on display at the monitor 105 information indicating that the particular image file is an MPF file, in the form of a folder icon 4c, and also displays thumbnail data for the images recorded in the MPF file by stacking the thumbnails within the icon 4c. As a result, the user is able to visually ascertain that the image file is an MPF file. In addition, the control device 103 reads out the rating information included in the common additional information 2e in the MPF file and displays a star index 4d, indicating the rating thus read out, in relation to the icon 4c. The user is thus able to view the rating information set for the MPF file corresponding to the icon 4c on display.

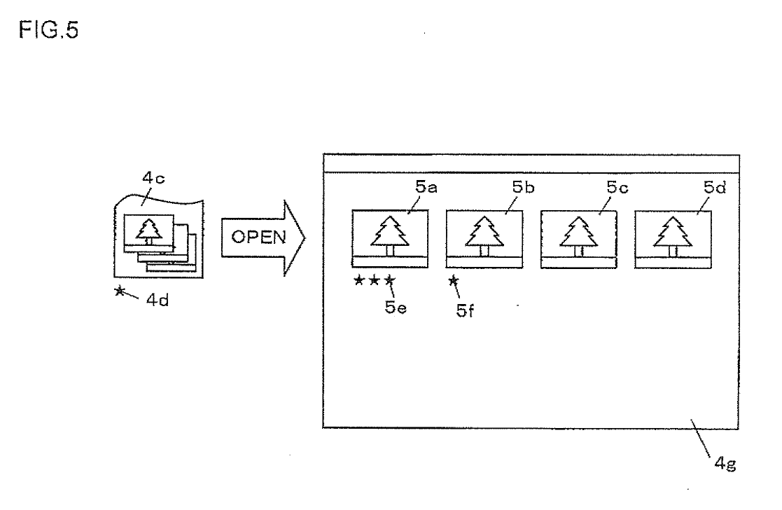

As the user operates the operation member 101 to issue an instruction to open the folder represented by the icon 4c, the control device 103 brings up on display at the monitor 105 a window 4g that provides the contents of the folder represented by the icon 4c, as shown in FIG. 5. The control device 103 brings up an at-a-glance display of thumbnail images 5a through 5d for the sets of main image data, which are recorded in the MPF file, within the window 4g. In addition, the control device 103 reads out the rating information included in the individual additional information 2d for the individual sets of main image data within the MPF file and displays star indices 5e and 5f, indicating the ratings thus read out, in relation to the corresponding thumbnail images. It is to be noted that in the example presented in FIG. 5, rating information is set for the main image data corresponding to the thumbnail images 5a and 5b, whereas no rating information is set for the main image data corresponding to the thumbnail images 5c and 5d. The operation then proceeds to step S30 to be described in detail later.

However, if an affirmative decision is made in step S40, i.e., if the display target MPF file is judged to contain images having been obtained through panorama shooting, the operation proceeds to step S60. In step S60, the control device 103 reads out the thumbnail image data for all the main image data in the MPF file and creates a single panoramic image by stitching them together. The operation then proceeds to step S70, in which the control device 103 displays the panoramic image 4e having been created, at the monitor 105, as shown in FIG. 4. In addition, the control device 103 reads out the rating information included in the common additional information 2e in the MPF file and displays a star index 4f, indicating the rating thus read out, in relation to the panoramic image 4e.

As a result, the user is able to view the rating information set for the MPF file corresponding to the panoramic image 4; as well as the synthetically created panoramic image 4e. It is to be noted that the common additional information 2e in an MPF file containing images obtained through panorama shooting will include the rating information for the panoramic image recorded as the common rating information pertinent to the entire MPF file and, accordingly, the rating information read out from the common additional information 2e will be displayed in relation to the panoramic image 4e. Subsequently, the operation proceeds to step S30.

In step S30, the control device 103 makes a decision as to whether or not there is any image file yet to be brought up on display at the monitor 105 remaining in the folder specified by the user. If an affirmative decision is made in step S30, the operation returns to step S10 to repeatedly execute the processing described above. If on the other hand, a negative decision is made in step S30, the processing ends.

Next, rating processing executed to set the rating information for an image file is described. FIG. 6 presents a flowchart of the rating processing executed in the embodiment. The processing shown in FIG. 6 is executed by the control device 103 with a program started up as the power to the personal computer 100 is turned on.

In step S110, the control device 103 makes a decision as to whether or not the user has operated the operation member 101. If an affirmative decision is made in step S110, the operation proceeds to step S120. In step S120, the control device 103 makes a decision as to whether or not the operation performed by the user was an image rating operation. If a negative decision is made in step S120, the operation proceeds to step S130, in which the control device 103 executes processing corresponding to the user operation, before the operation returns to step S110. If, on the other hand, an affirmative decision is made in step S120, the operation proceeds to step S140.

In step S140, the control device 103 makes a decision as to whether or not the target of the rating operation having been performed by the user is an MPF file. If a negative decision is made in step S140, i.e., if it is decided that the rating operation has been performed for a JPEG file, the operation proceeds to step S150, in which the control device 103 sets a rating for the JPEG file by recording rating information as part of the additional information in the JPEG file in correspondence to the rating operation having been performed by the user.

If, on the other hand, an affirmative decision is made in step S140, the operation proceeds to step S160, in which the control device 103 makes a decision as to whether or not the target MPF file has been created through a panorama shooting session. If an affirmative decision is made in step S160, the operation proceeds to step S190 to be described later. However, if a negative decision is made in step S160, the operation proceeds to step S170.

In step S170, the control device 103 makes a decision as to whether or not the rating operation has been performed for the individual sets of main image data in the image file. If an affirmative decision is made in step S170, the operation proceeds to step S180, in which the control device 103 sets a rating for each set of main image data having been rated by the user by recording rating information as part of the individual additional information 2d for the particular main image data within the MPF file in correspondence to the rating operation having been performed by the user, and then the operation returns to step S110. If, on the other hand, a negative decision is made in step S170, i.e., if it is decided that the rating operation has been performed for the entire MPF file, the operation proceeds to step S190.

In step S190, the control device 103 sets a rating for the MPF file by recording rating information as part of the common additional information 2e in the MPF file in correspondence to the rating operation having been performed by the user and then the operation returns to step S110.

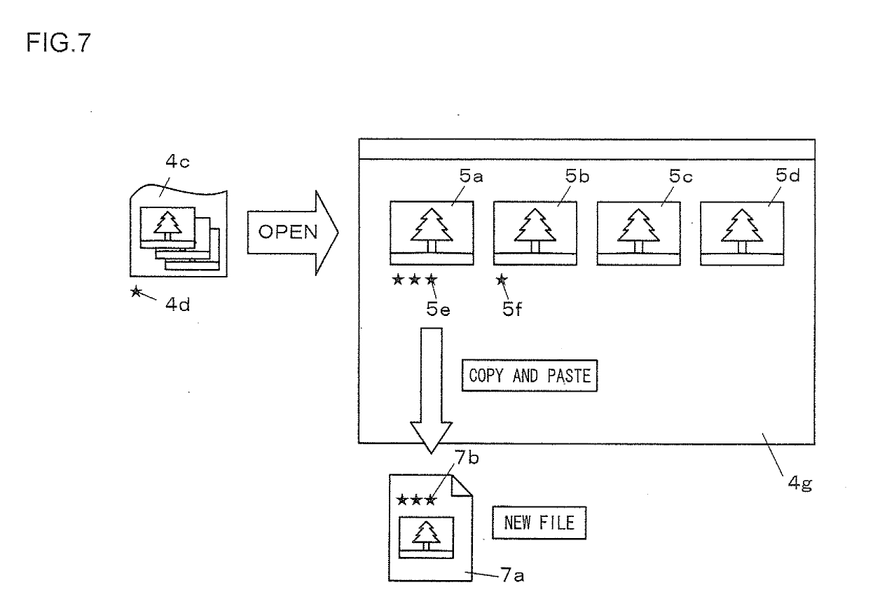

In the embodiment, a new image file can be created based upon at least one set of main image data included in an MPF file for which rating information has been set through the rating processing described above. In more specific terms, a new JPEG file can be created based upon a single set of main image data included in an MPF file and a new MPF file can be created based upon at least two sets of main image data included in an MPF file. For instance, the user is able to issue an instruction by selecting the thumbnail image 5a, included in the window 4g in FIG. 5, which corresponds to main image data he wishes to include in a new image file, and then copying and pasting the selected thumbnail image at a position outside the window 4g, as shown in FIG. 7, so as to create a new image file 7a containing the main image data corresponding to the selected thumbnail image 5a.

In this situation, if the image file 7a to be newly created is a JPEG file, the control device 103 copies the individual additional information 2d, which corresponds to the main image data having been copied, from the copy source MPF file 4c and records the individual additional information thus copied as additional information in the new JPEG file 7a. As a result, the rating information 5e having been set for the main image data in the initial MPF file is carried over as rating information 7b for the new JPEG file 7a.

If on the other hand, the image file 7a to be newly created is an MPF file, the following processing is executed, depending upon whether the copy source MPF file 4c contains images having been obtained through continuous shooting or panorama shooting.

If the copy source MPF file 4c contains a batch of images having been photographed through continuous shooting, the control device 103 copies sets of individual additional information 2d, each corresponding to one of the plurality of sets of main image data having been copied, from the copy source MPF file 4c and records the copied individual additional information as individual additional information 2d corresponding to the individual sets of main image data in the new MPF file 7a. Through this processing, the rating information set for the sets of main image data used to create the initial MPF file is carried over as rating information corresponding to the sets of main image data in the new MPF file 7a. It is to be noted that whenever a new MPF file 7a is created, a screen allowing the user to choose whether or not to add the rating information in the new MPF file 7a may be brought up on display. At this time, a screen that allows the user to choose, through user operation, whether to directly carry the rating information set in the copy source MPF file 4c over to the new MPF file or to modify the rating information, may be brought up on display.

If the copy source MPF file 4c has been created through a panorama shooting session, on the other hand, the control device 103 copies the common additional information 2e from the copy source MPF file 4c and records it into the new MPF file 7a as common additional information. Through this processing, the rating information 4d set in the MPF file 4c used as a source MPF file for the new MPF file 7a is carried over as the rating information in the new MPF file 7a.

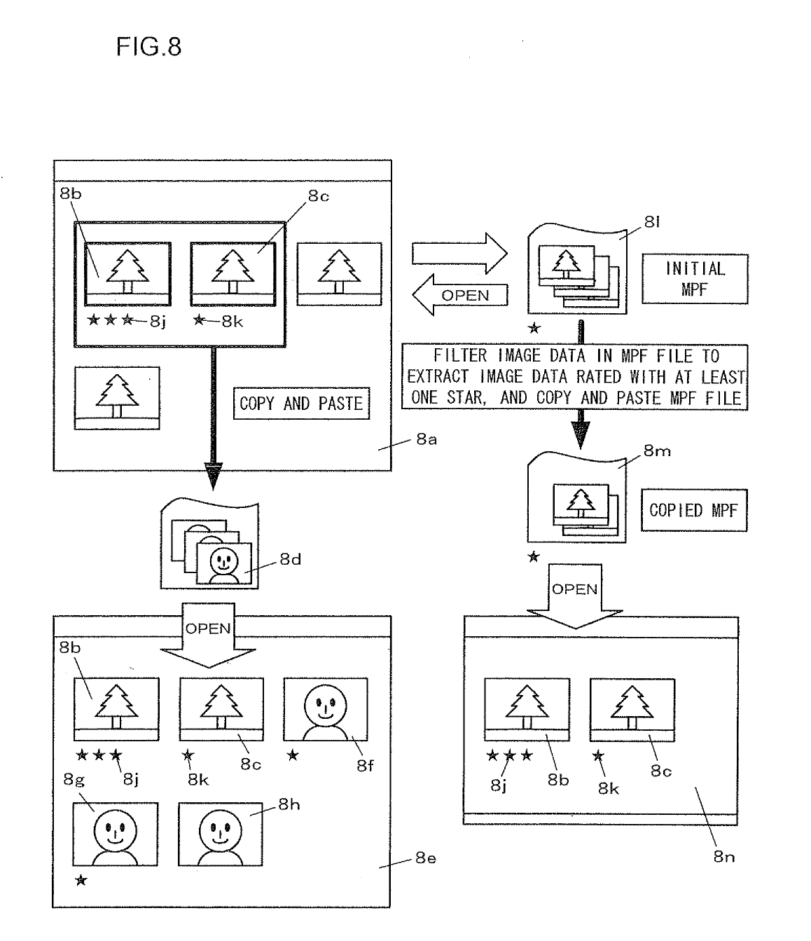

In addition, main image data in another image file can be copied and added into an MPF file in the embodiment. For instance, the user may select thumbnails 8b and 8c, included in a window 8a providing the contents of a copy source MPF file, which correspond to main image data he wishes to include in the new image file, and copy and paste the selected thumbnail images over an icon 8d representing the recipient MPF file to which the main image data are to be added, as shown in FIG. 8, so as to add the main image data corresponding to the thumbnail images 8b and 8c into the copy recipient MPF file.

The thumbnail images displayed inside a window 8e in FIG. 8 indicate that the copy recipient MPF file, initially containing main image data corresponding to thumbnail images 8f, 8g and 8h recorded therein, now also include additional main image data corresponding to the thumbnail images 8b and 8c.

In this situation, the control device 103 copies the individual additional information 2d for the main image data having been copied from the copy source MPF file and records the copied individual additional information as individual additional information 2d for the copied main image data in the copy recipient MPF file. As a result, rating information 8j and rating information 8k set for the sets of main image data having been copied are carried over as the rating information for the respective sets of main image data in the copy recipient MPF file. Namely, whenever a new set of image data is copied into a copy recipient MPF file, the rating information appended to the copied image data is carried over together with the image data, regardless of the rating information included in the common additional information in the copy recipient MPF file.

It is to be noted that once main image data are added, the control device 103 modifies the additional information 2e for the entire image file 2c in FIG. 2C. Namely, the control device 103 modifies the information pertaining to, for instance, the image data in the MPF file represented by the icon 8d. In more specific terms, the control device 103 modifies the information by indicating the presence of the main image data corresponding to the thumbnail images 8b and 8c within the MPF file and by altering the order with which the individual sets of main image data are stored within the MPF file. Upon modifying the information, the control device 103 actually adds the main image data into the MPF file in compliance with the storage order indicated in the information. In addition, if the newly created image file 7a is an MPF file, the control device 103 modifies the additional information 2e for the entire file. More specifically, it modifies the information related to the main image and the like present within the newly created MPF image, the storage order with which the individual sets of main image data are stored and the like.

The embodiment further allows the user to search for and specify desired main image data to be copied from a copy source MPF file based upon the rating information and create a new image file containing only main image data satisfying a search condition or add main image data satisfying the search condition into a copy recipient MPF file. More specifically, the user is able to designate a set of main image data with the rating thereof equal to or higher than a specific level alone, among the plurality of sets of main image data in the copy source MPF file, as copy target main image data.

For instance, as illustrated in FIG. 8, after the user sets as a search condition to search a specific copy target main image data; “rated with at least one star” for an icon 81 representing the copy source MPF file, the user can copy and paste the icon 81 in an empty space on the screen so as to issue an instruction for creating a new MPF file containing only the main image data satisfying the search condition. In this case, in response to the instruction issued by the user, the control device 103 extracts the main image data rated with at least one star alone from the copy source MPF file and creates a new MPF file containing the extracted main image data.

The MPF file represented by the icon 81 in FIG. 8 contains main image data corresponding to the thumbnail images displayed inside the window 8a and, accordingly, the main image data corresponding to the thumbnail images 8b and 8c are extracted in compliance with the search condition and a new MPF file containing these main image data is created. The control device 103 then brings up on display an icon 8m representing the newly created MPF file at the monitor 105.

In this situation, the control device 103 copies the individual additional information 2d for the main image data having been copied from the copy source MPF file and records the copied additional information as individual additional information 2d for the corresponding copied main image data copied into the newly created MPF file. As a result, the initial rating information 8j and rating information 8k set for the sets of main image data having been copied are carried over as the rating information for the respective sets of main image data in the copy recipient MPF file, as indicated in a window 8n in FIG. 8.

It is to be noted that while an explanation is given above on an example in which after the user has indicated a specific search condition for the icon 81 representing the copy source MPF file, then the user creates a new MPF file containing the main image data satisfying the search condition alone by copying and pasting the icon 81 in an available space on the screen, the user, having indicated a specific search condition for the icon 81, may copy and paste the icon 81 over the icon 8d representing another MPF file so as to add the main image data satisfying the search condition into the other MPF file represented by the icon 8d.

The following advantages are achieved through the embodiment described above.

(1) Common additional information, which can be set by the user as shared information applicable to all the main image data contained in an MPF file, and individual additional information, which, can be set by the user individually for each set of main image data in the MPF file, are recorded in the MPF file. The control device 103 modifies the common additional information based upon rating information set by the user for the particular MPF file and also modifies the sets of individual additional information, each corresponding to a set of main image data based upon rating information set by the user for the individual sets of main image data in the MPF file. Through these measures, the common additional information and the individual additional information in the MPF file can each be managed as information distinguishable from the other.

(2) The control device 103, which is able to create a new image file based upon at least one set of main image data contained in an MPF file, records at least either the common additional information or the individual additional information, initially recorded in the source MPF file, into the new image file. As a result, the rating information set in the source MPF file can be carried over into the new image file created based upon main image data in the source MPF file.

(3) If the copy source MPF file 4c has been created through a continuous shooting operation, the control device 103 copies the sets of individual additional information 2d, each corresponding to one of the plurality of sets of main image data having been copied, from the copy source MPF file 4c, and records the copied individual additional information into the new MPF file 7a as individual additional information 2d corresponding to the individual sets of main image data in the new MPF file 7a. Thus, whenever a new MPF file 7a is created based upon the copy source MPF file 4e containing images photographed through a continuous shooting operation, the rating information set for the copied main image data can be carried over into the new MPF file 7a by taking into consideration that the images contained in the source MPF file are sets of image data independent of one another.

(4) If the copy source MPF file 4c contains image data obtained through a panorama shooting session, the control device 103 copies the common additional information 2e from the copy source MPF file 4c and records the copied common additional information as common additional information 2e into the new MPF file 7a. As a result, the rating information 4d initially set in the creation source MPF file 4c used to create the new MPF file 7a can be carried over into the MPF file 7a by taking into consideration that the main image data in the MPF file are a set of image data used in combination whenever the copy source MPF file 4c has been created as a result of a panorama shooting session. However, even when the copy source MPF file 4c contains image data obtained through a panorama shooting session, the photographic ranges of the sets of main image data to be included in the new MPF file 7a may not be continuous to one another. In such a case, the new MPF file created in the embodiment may inherit the rating information initially set for the individual sets of main image data having been copied.

(5) When adding main image data copied from another image file, into an MPF file, the control device 103 copies the individual additional information 2d for the main image data having been copied from the copy source MPF file, and records the individual additional information into the copy recipient MPF file as individual additional information 2d for the copied main image data. As a result, the rating information 83 and the rating information 8k set for the sets of main image data having been copied are carried over as rating information for the respective sets of main image data in the copy recipient MPF.

(6) As the user sets a rating for the main image data in an MPF file created through a continuous shooting operation, the control device 103 records the rating information as part of the individual additional information 2d, whereas, as the user sets a rating for image data in an MPF file created as a result of a panorama shooting session, the control device 103 records the rating information as part of the common additional information. As a result, whenever sets of image data that are independent of one another are obtained through a continuous shooting operation, each set of main image data can be independently rated, whereas whenever main image data are obtained through a panorama shooting session as a single set of image data constituting a single panoramic image, the MPF file as a whole can be rated.

—Variations—

It is to be noted that the personal computer achieved in the embodiment described above allows for the following variations.

(1) When the display target MPF file is an image file obtained through a panorama shooting session, the control device 103 creates a single panoramic image by combining the thumbnail image data corresponding to all the main image data included in the MPF file and displays the panoramic image 4e thus created at the monitor 105. At this time, the control device 103 may also display the thumbnail images each corresponding to one of the sets of main image data, which constitute the panoramic image 4e in response to a user instruction.

(2) When creating a new image file based upon at least one set of main image data included in a source MPF file 4c having been created as a result of a panorama shooting session, the control device 103 copies the common additional information 2e from the source MPF file 4c and records the common additional information as additional information for the new MPF file 7a. Since the plurality of sets of main image data included in the MPF file resulting from the panorama shooting session are a group of image files used to create a single panoramic image, any attempt by the user to create a new image file based upon only some of the main image data in the group may be prohibited, with a message brought up on display to indicate that a new image file cannot be created.

(3) In the embodiment described above, when adding main image data copied from another image file into an MPF file, the control device 103 copies the individual additional information 2d for the main image data having been copied from the copy source MPF file, and records it as individual additional information 2d for the copied main image data into the copy recipient MPF file. If no individual additional information 2d is recorded in the copy source MPF file correspondence to the main image data having been copied, the control device 103 may instead copy the common additional information 2e recorded in the copy source MPF file and record it as individual additional information 2d for the copied main image data into the copy recipient MPF file.

(4) In the embodiment described above, the present invention is adopted in the personal computer 100. However, the present invention may be adopted in another type of device capable of recording image files, such as a digital camera or a portable information terminal.

(5) When creating a new image file 7a as a JPEG file, the individual additional information 2d for the main image data having been copied is copied from the copy source MPF file 4c and the individual additional information thus copied is recorded into the new JPEG file 7a as additional information. As an alternative, the additional information to be carried over into the new JPEG file 7a may be switched in correspondence to the specific category to which the copy source MPF file 4c belongs. For instance, if the copy source MPF file 4c has been created as a result of a continuous shooting operation, the individual additional information 2d corresponding to the copied main image data may be carried over. If, on the other hand, the copy source MPF file 4c has been created as a result of a panorama shooting session, the rating information 4d set for the copy source MPF file 4c may be carried over to the new JPEG file 7a. As a further alternative, the new JPEG file 7a may inherit both the rating information 4d set for the copy source MPF file 4c and the rating information (5c or 5f) set for the particular set of main image data. In this case, if the copy source MPF file 4c has been created as a result of for instance, a panorama shooting session, the rating information 4d set for the copy source MPF file 4c may be recorded in a public area of the new JPEG file 7a and the rating information (5e or 5f) set for the particular set of main image data may be recorded in a special area that each manufacturer is allowed to set for itself.

(6) In the embodiment described above, whenever new image data are copied into the copy recipient MPF file, the rating information appended to the copied image data is carried over into the copy recipient MPF file, irrespective of the rating information included in the common additional information for the copy recipient MPF file. However, optimal rating information for the image data newly copied into the recipient MPF file may be determined by comparing the rating information included in the common additional information for the copy recipient MPF file with the rating information included in the common additional information for the copy source MPF file. For instance, if it is decided by comparing the rating information included in the common additional information in the two MPF files that the rating information included in the common additional information in the copy source MPF file indicates a higher rating, the rating information appended to the copied image data may be modified to indicate a higher rating. If; on the other hand, the rating information included in the common additional information in the copy recipient MPF file indicates a higher rating, the rating information appended to the copy image data may be modified to indicate a lower rating. If the rating information included in the common additional information in the copy source MPF and the rating information included in the common additional information in the copy recipient MPF file indicate equal ratings, the rating information initially appended to the copied image data should be directly carried over.

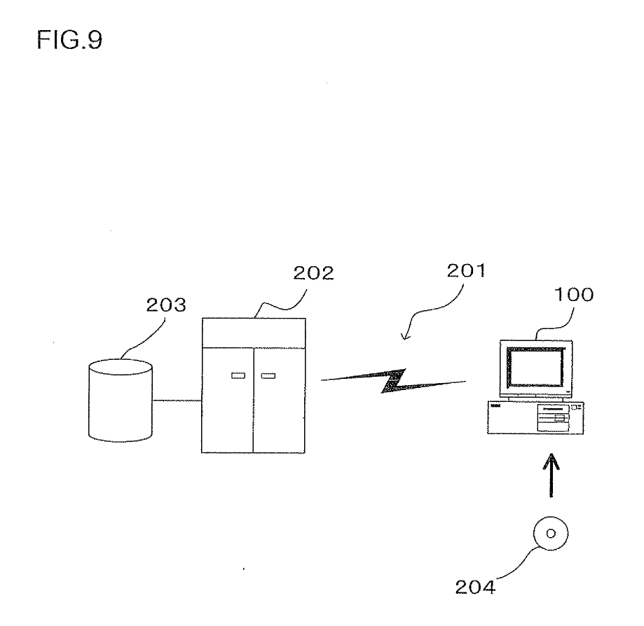

The following is a description of how the programs enabling the processing described earlier may be provided to the personal computer 100 via a storage medium such as a CD-ROM or a DVD-ROM with the programs recorded therein. The programs may also be provided through the Internet. FIG. 9 shows how the programs may be provided. The personal computer 100 receives the programs provided via a CD-ROM (or a DVD-ROM) 204. The personal computer 100 is also capable of establishing a connection with a communication line 201. A computer 202 is a server computer that provides the programs stored in a recording medium such as a hard disk 203. The communication line 201 may be a communication network such as the Internet or it may be a dedicated communication line. The computer 202 transmits a program read out from the hard disk 203, to the personal computer 100 via the communication line 201. Namely, the programs may be transmitted as data signals on a carrier wave via the communication line 201. In short, the programs may each be distributed as a computer-readable computer program product adopting any of various modes, including a recording medium and a data signal (carrier wave).

It is to be noted that the embodiment described above simply represents an example and the present invention is in no way limited to this example as long as the functions characterizing the present invention remain intact. In addition, the embodiment may be adopted in combination with a plurality of variations.

What is claimed is:

1. An image recording device, comprising:
a recording unit that records into a first image file that contains a plurality of sets of image data, common information that can be set by a user as information commonly applicable to all sets of image data in the first image file and individual information that can be individually set by the user for each set of image data in the first image file; and
an information modifying unit that modifies the common information based upon information set for the first image file and modifies the individual information corresponding to image data in the first image file based upon information set for the image data.

2. An image recording device according to claim 1, further comprising:
an image file creation unit that creates a second image file based upon at least one set of image data in the first image file, wherein:
the recording unit carries over at least either the common information or the individual information having been recorded in the first image file used as a source for creating the second image file and records carried over information into the second image file created by the image file creation unit.

3. An image recording device according to claim 2, wherein:
if the first image file has been created as a result of a continuous shooting operation, the recording unit carries over the individual information in the first image file and records the carried over individual information into the second image file, and if the first image file has been created as a result of a multiple viewpoint shooting operation, the recording unit carries over the common information from the first image file and records the carried over common information into the second image file.

4. An image recording device according to claim 1, further comprising:
an image data adding unit that additionally records image data originating from a third image file into the first image file, wherein:
when image data are added into the first image file by the image data adding unit, the recording unit records the individual information recorded in the third image file, which pertains to the image data having been added, as the individual information for the image data having been added into the first image file.

5. An image recording device according to claim 4, wherein:
if no individual information is recorded in the third image file in correspondence to image data in the third image file, the recording unit records the common information recorded in the third image file as the individual information pertaining to the image data having been added into the first image file.

6. An image recording device according to claim 1, wherein:
the information modifying unit determines whether the common information or the individual information is to be modified, in correspondence to a specific photographing method through which the plurality of sets of image data in the first image file have been obtained.

7. An image recording device according to claim 6, wherein:
if the photographing method is a continuous shooting method, the information modifying unit modifies the individual information based upon the information set for the image data in the first image file, and if the photographing method is a multiple viewpoint shooting method, the information modifying unit modifies the common information based upon the information set for the image data in the first image file.

8. A computer program product that includes an image recording program enabling a computer to execute:
a recording step of recording into a first image file containing a plurality of sets of image data, common information that can be set by a user as information applicable to all sets of image data in the first image file, and individual information that can be set by the user individually for each set of image data in the first image file; and
an information modifying step of modifying the common information based upon information set for the first image file, and the individual information corresponding to image data in the first image file based upon information set for the image data.
